(19) United States
(12) Patent Application Publication
(10) Pub. No.: US 2017/0264913 A1
(43) Pub. Date: Sep. 14, 2017

(54) IMAGE DECODING DEVICE, IMAGE PROCESSING SYSTEM, AND IMAGE DECODING METHOD

(71) Applicant: FUJITSU LIMITED, Kawasaki-shi (JP)

(72) Inventors: Kimihiko KAZUI, Kawasaki (JP); Tomonori KUBOTA, Kawasaki (JP); Satoshi SHIMADA, Kawasaki (JP); KOHJI YAMADA, Kawasaki (JP); Kenshiro Takeuchi, Kawasaki (JP)

(73) Assignee: FUJITSU LIMITED, Kawasaki-shi (JP)

(21) Appl. No.: 15/606,534

(22) Filed: May 26, 2017

Related U.S. Application Data
(63) Continuation of application No. PCT/JP2014/081689, filed on Dec. 1, 2014.

(51) Int. Cl. H04N 19/513; H04N 19/44

(52) U.S. Cl. CPC H04N 19/513; H04N 19/44

(57) ABSTRACT

A processor requests a first stream encoded by irreversible encoding from an encoding device, decodes the first stream, generates a first decoded image from a first encoded image obtained by encoding one image, and outputs the first decoded image. Then, the processor requests a second stream from the encoding device. The second stream includes a second encoded image obtained by applying inter-prediction to the one image and by encoding a prediction error by reversible encoding, the inter-prediction using a locally decoded image obtained by decoding the first encoded image as a reference image and using a motion vector for which a magnitude is 0. The processor decodes the second stream, generates a second decoded image from the second encoded image, generates a third decoded image that corresponds to the first decoded image by using a result of adding the first and second decoded images, and outputs the third decoded image.

### CROSS-REFERENCE TO RELATED APPLICATION

This application is a continuation application of International Application PCT/JP2014/081689 filed on Dec. 1, 2014 and designated the U.S., the entire contents of which are incorporated herein by reference.

### FIELD

The embodiments discussed herein are related to an image decoding device, an image processing system, and an image decoding method.

### BACKGROUND

Moving image data often has a very large amount of data. Therefore, when moving image data is transmitted from a transmitter to a receiver, or when moving image data is stored in a storage, compression encoding is performed on the moving image data.

A representative moving image encoding standard has been developed by the International Organization for Standardization/International Electrotechnical Commission (ISO/IEC). A moving image encoding standard has also been developed by the International Telecommunication Union Telecommunication Standardization Sector (ITU-T).

As these encoding standards, moving picture experts group phase 2 (MPEG-2, ITU-T H.262|ISO/IEC 13818-2) and advanced video coding (AVC, ITU-T H.264|ISO/IEC 14496-10) are known, for example. Further, high efficiency video coding (HEVC, ITU-T H.265|ISO/IEC 23008-2) is also known.

The moving image encoding standards above employ two encoding schemes, inter-prediction encoding and intra-prediction encoding. Inter-prediction encoding is an encoding scheme for encoding an image to be encoded that corresponds to one picture in a moving image by using information relating to an image already encoded, and intra-prediction encoding is an encoding scheme for encoding an image to be encoded by using only information included in the image to be encoded.

Compression encoding of moving image data is classified into lossless encoding and lossy encoding from the viewpoint of whether an image before compression encoding completely matches an image after expansion decoding. Lossless encoding is reversible encoding in which an image before compression encoding completely matches an image after expansion decoding, and lossy encoding is irreversible encoding in which the image before compression encoding does not match the image after expansion decoding. Lossy encoding can reduce a larger amount of information of an encoded image than lossless encoding, but as a degree of reduction of the amount of information increases, an error between an original image and a decoded image increases.

H.264 and HEVC described above meet both lossless encoding and lossy encoding. These encoding standards achieve a high compression efficiency by removing redundancy in a spatial direction by performing discrete cosine transform (DCT), which is one method of frequency conversion. However, a specified DCT is an irreversible operation, and therefore it has been specified that DCT is not performed at the time of lossless encoding.

In addition to moving image encoding, joint photographic experts group 2000 (JPEG 2000, ISO/IEC 15444) and JPEG-LS (ISO/IEC 14495), which are schemes for encoding a still image, meet both lossless encoding and lossy encoding. JPEG 2000 removes redundancy similarly to DCT by performing discrete wavelet transform (DWT), which is one method of frequency conversion. DWT of JPEG 2000 is a reversible operation, and therefore DWT is performed even at the time of lossless encoding.

An encoding device is also known that scalably encodes a digital input signal and generates a base layer code and one or more enhancement layer codes (see, for example, Patent Document 1). This encoding device performs lossless encoding on the base layer code, generates a lossless code, and selects a combination for which a code amount per unit time is smaller than or equal to an available transmission band and the code amount per unit time is the largest, from among plural types of combinations of a lossless code and an enhancement layer code.

Patent Document 1: Japanese Laid-open Patent Publication No. 2012-88502

### SUMMARY

According to an aspect of the embodiments, an image decoding device includes a memory and a processor coupled to the memory.

The processor requests a first encoded stream including a first encoded image from an image encoding device that generates the first encoded stream by encoding a plurality of images to be encoded by irreversible encoding, the first encoded image being obtained by encoding one image to be encoded from among the plurality of images to be encoded. Then, the processor receives the first encoded stream from the image encoding device, and generates a first decoded image from the first encoded image by decoding the first encoded stream. The processor stores the first decoded image in the memory, and outputs the first decoded image.

Then, the processor requests a second encoded stream including a second encoded image from the image encoding device, the second encoded image being obtained by applying inter-prediction to the one image to be encoded and by encoding a prediction error by reversible encoding, the inter-prediction using a locally decoded image obtained by decoding the first encoded image as a reference image and using a motion vector for which a magnitude is 0. The processor receives the second encoded stream from the image encoding device, and generates a second decoded image from the second encoded image by decoding the second encoded stream.

The processor generates a third decoded image that corresponds to the first decoded image by using an addition result of adding the first decoded image and the second decoded image, and outputs the third decoded image.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of an image processing system;

FIG. 2 is a block diagram of an image encoding device;

FIG. 3 is a block diagram of an image decoding device;

FIG. 4 is block diagrams of a decoding circuit and a generation circuit;

FIG. 5 illustrates encoded data;

FIG. 6 is a flowchart of image encoding processing;

FIG. 7 is a flowchart of image decoding processing; and

FIG. 8 is a block diagram of an information processing device.

### DESCRIPTION OF EMBODIMENTS

Embodiments are described below in detail with reference to the drawings.

Lossless encoding is applied, for example, in fields that assure originality of image data. Specifically, lossless encoding may be applied to image data in the medical field or the like. Medical images that are captured by using examination devices (modality devices) such as computed tomography (CT) devices are obliged to be stored, and lossless encoding is recommended for diagnostic applications. However, when a medical image is temporarily referred to in a remote area, lossy encoding in which an amount of information is smaller may be allowed in order to reduce data transmission time.

In compression encoding of medical images, a still image encoding scheme such as JPEG 2000 is widely used. This is because JPEG 2000 exhibits a high compression performance in lossless encoding applied in diagnosis or storing of original medical images that is a conventional main application in the medical field.

Frequency conversion is not applied to a lossless encoding mode according to AVC, and therefore the compression performance of the lossless encoding mode according to AVC is lower than that of JPEG 2000. This difference in performance is not generated only at the time of intra-prediction encoding of each image, but is similarly generated at the time of inter-prediction encoding of consecutive image sequences (for example, a multi-slice CT image). In the moving image encoding scheme, the compression performance of inter-prediction encoding is often equal to the compression performance of intra-prediction encoding at the time of lossless encoding.

As an example, in the medical field, attempts to improve the quality of medical care, such as enabling a patient to receive an appropriate treatment even at a visit place by sharing medical images captured in respective hospitals via a communication network within the community, are being made. In this case, it is preferable that both lossless encoding and lossy encoding be applied to the medical images in order to meet an application of referring to the medical images at a remote place, in addition to applications of diagnosis and storing of original medical images.

In an image encoding device, when lossless encoding and lossy encoding are individually applied to one medical image, two compressed images are generated, and a data amount increases in comparison with a case in which only one encoding scheme is handled. In the medical field, medical images of many patients are handled, and therefore an increase in the data amount as described above becomes a significant problem. As an example, when two compressed images for one medical image are transmitted from an image encoding device to an image decoding device, a large number of resources of a communication network are consumed.

The problem above does not arise only in a case in which a medical image is encoded by using lossless encoding and lossy encoding, but also arises in a case in which another image is encoded.

An image encoding device according to the embodiments encodes an input moving image signal in image (picture) units according to the HEVC standard. At this time, quality scalable video coding is applied to respective images by using a scalable encoding function according to HEVC (scalable HEVC, SHVC). This quality scalable video coding is configured by two layers, a base layer in which lossy encoding is performed and an enhancement layer in which lossless encoding is performed.

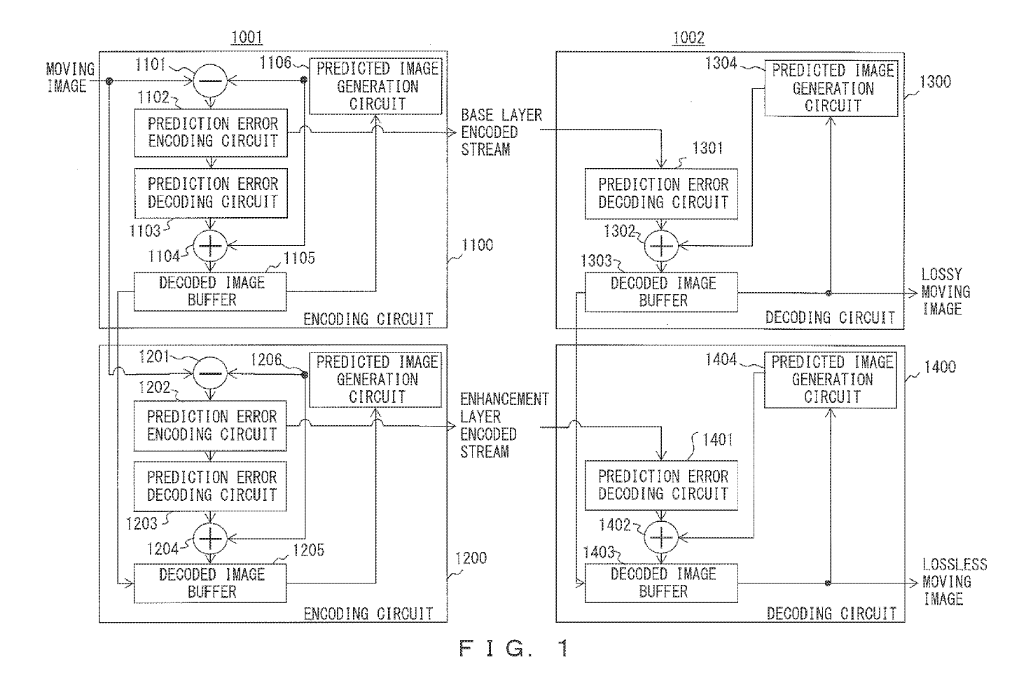

FIG. 1 illustrates an exemplary configuration of an image processing system that performs quality scalable video coding in the case of two layers, one base layer and one enhancement layer. In quality scalable video coding, a plurality of enhancement layers may be used instead of one enhancement layer.

The image processing system illustrated in FIG. 1 includes an image encoding device 1001 and an image decoding device 1002. The image encoding device 1001 and the image decoding device 1002 can perform communication, for example, via a communication network. The image encoding device 1001 includes an encoding circuit (an encoder) 1100 of the base layer and an encoding circuit (an encoder) 1200 of the enhancement layer, and the image decoding device 1002 includes a decoding circuit (a decoder) 1300 of the base layer and a decoding circuit (a decoder) 1400 of the enhancement layer.

The encoding circuit 1100 includes a subtraction circuit (a subtracter) 1101, a prediction error encoding circuit (a prediction error encoder) 1102, a prediction error decoding circuit (a prediction error decoder) 1103, an addition circuit (an adder) 1104, a decoded image buffer 1105, and a predicted image generation circuit (a predicted image generator) 1106.

The subtraction circuit 1101 subtracts a pixel value (a predicted value) of a predicted image generated by the predicted image generation circuit 1106 from a pixel value of an image to be encoded that is included in an input moving image, and generates a prediction error that is a difference between the image to be encoded and the predicted image. The prediction error encoding circuit 1102 encodes the prediction error generated by the subtraction circuit 1101. Encoding performed by the prediction error encoding circuit 1102 includes entropy encoding. The encoded prediction error is output as an encoded image of the base layer, and an encoded stream including the encoded image of the base layer is transmitted to the image decoding device 1002.

The prediction error decoding circuit 1103 decodes the encoded prediction error, and generates a prediction error in which encoding distortion is superimposed onto the prediction error generated by the subtraction circuit 1101. The addition circuit 1104 adds the pixel value of the predicted image generated by the predicted image generation circuit 1106 to the prediction error in which the encoding distortion is superimposed, and generates a locally decoded image including distortion. The decoded image buffer 1105 stores the locally decoded image generated by the addition circuit 1104.

The predicted image generation circuit 1106 generates a predicted value from the locally decoded image stored in the decoded image buffer 1105. A prediction mode applied in the predicted image generation circuit 1106 is either an intra-prediction mode for generating a predicted value from a pixel value of a pixel already encoded of the image to be encoded of the base layer or an inter-prediction mode for using an image already encoded of the base layer as a reference image.

The encoding circuit 1200 includes a subtraction circuit (a subtracter) 1201, a prediction error encoding circuit (a prediction error encoder) 1202, a prediction error decoding circuit (a prediction error decoder) 1203, an addition circuit (an adder) 1204, a decoded image buffer 1205, and a predicted image generation circuit (a predicted image generator) 1206.

The subtraction circuit 1201 subtracts a predicted value generated by the predicted image generation circuit 1206 from a pixel value of an image to be encoded, and generates a prediction error that is a difference between the image to be encoded and the predicted image. The prediction error encoding circuit 1202 encodes the prediction error generated by the subtraction circuit 1201. Encoding performed by the prediction error encoding circuit 1202 includes entropy encoding. The encoded prediction error is output as an encoded image of the enhancement layer, and an encoded stream including the encoded image of the enhancement layer is transmitted to the image decoding device 1002.

The prediction error decoding circuit 1203 decodes the encoded prediction error, and generates a prediction error without distortion that is the same as the prediction error generated by the subtraction circuit 1201. The addition circuit 1204 adds the predicted value generated by the predicted image generation circuit 1206 to the prediction error without distortion, and generates a locally decoded image. The decoded image buffer 1205 stores the locally decoded image generated by the addition circuit 1204, and also stores the locally decoded image with distortion of the base layer that has been stored in the decoded image buffer 1105.

The predicted image generation circuit 1206 generates a predicted value from the locally decoded image stored in the decoded image buffer 1205. A prediction mode applied in the predicted image generation circuit 1206 is either an intra-prediction mode for generating a predicted value from a pixel value of a pixel already encoded of an image to be encoded of the base layer or an inter-prediction mode. In the inter-prediction mode, an image already encoded of the base layer or an image already encoded of the enhancement layer is used as a reference image.

The decoding circuit 1300 includes a prediction error decoding circuit (a prediction error decoder) 1301, an addition circuit (an adder) 1302, a decoded image buffer 1303, and a predicted image generation circuit (a predicted image generator) 1304.

The prediction error decoding circuit 1301 decodes an encoded image that is included in an encoded stream of the base layer that is output from the encoding circuit 1100, and generates a prediction error onto which encoding distortion is superimposed. The addition circuit 1302 adds a predicted value generated by the predicted image generation circuit 1304 to the prediction error onto which the encoded distortion is superimposed, and generates a decoded image with distortion.

The decoded image buffer 1303 stores the decoded image generated by the addition circuit 1302. The decoded image is output as a lossy moving image, and is displayed on a screen. The predicted image generation circuit 1304 generates an inter-prediction image or an intra-prediction image from the decoded image stored in the decoded image buffer 1303.

The decoding circuit 1400 includes a prediction error decoding circuit (a prediction error decoder) 1401, an addition circuit (an adder) 1402, a decoded image buffer 1403, and a predicted image generation circuit (a predicted image generator) 1404.

The prediction error decoding circuit 1401 decodes an encoded image that is included in an encoded stream of the enhancement layer that is output from the encoding circuit 1200, and generates a prediction error without distortion. The addition circuit 1402 adds a predicted value generated by the predicted image generation circuit 1404 to the prediction error without distortion, and generates a decoded image without distortion.

The decoded image buffer 1403 stores the decoded image generated by the addition circuit 1402. This decoded image is output as a lossless moving image, and is displayed on the screen. The decoded image buffer 1403 also stores the decoded image with distortion of the base layer that has been stored in the decoded image buffer 1303. The predicted image generation circuit 1404 generates an inter-prediction image or an intra-prediction image from the decoded image stored in the decoded image buffer 1403.

In scalable encoding of a normal moving image, it is assumed that a moving image for which quality corresponds to the specification of the image decoding device 1002 is transmitted from the image encoding device 1001 to the image decoding device 1002. In this case, in order to provide a decoded image with a higher quality than that of a decoded image of the base layer, encoding the base layer and encoding the enhancement layer are performed simultaneously, and an encoded stream of the base layer and an encoded stream of the enhancement layer are transmitted simultaneously.

On the other hand, multi-slice CT images are slice images obtained by photographing the human body every several millimeters, and a frame rate is low in contrast to the normal moving image. When the multi-slice CT images above are displayed, a doctor first continuously observes slice images from a slice image of the head to a slice image of the toes as if the slice images were one continuous moving image, and observes a slice image of interest of the chest or the like in detail, in many cases.

At the time of continuous observation, a human visual characteristic is reduced, and therefore a lossy moving image is sufficiently usable. In particular, an encoded stream including plural slices is transmitted from the image encoding device 1001 to the image decoding device 1002 at the time of continuous observation, and a transmission rate can be reduced by transmitting only an encoded stream of the base layer, and the communication network can be used effectively.

Accordingly, the image encoding device 1001 according to the embodiments performs inter-prediction encoding on all coding units (CUs) in an image to be encoded in encoding the enhancement layer. Each of the CUs corresponds to a macroblock according to the AVC standard or the like. The image encoding device 1001 uses only a locally decoded image obtained by encoding the same image to be encoded in the base layer as a reference image in inter-prediction.

In the description below, an encoded image may refer to a result of encoding an image to be encoded that corresponds to the entirety of a screen, or may refer to a result of encoding a CU in the image to be encoded. In addition, a decoded image may refer to a result of decoding an encoded image that corresponds to an image to be encoded, or may refer to a result of decoding an encoded image that corresponds to a CU.

When reducing a data amount of received data for the purpose of reference at a remote place, or the like, the image decoding device 1002 according to the embodiments receives only a lossy encoded image of the base layer, expands and decodes the lossy encoded image, and displays the decoded image on the screen.

When displaying a lossless image for the purposes of diagnosis or the like, the image decoding device 1002 receives encoded images of the base layer and the enhancement layer, and expands and decodes a lossless encoded image. At this time, the circuit scale of the image decoding device 1002 can be reduced by independently decoding the base layer and the enhancement layer.

The image decoding device 1002 generates a decoded image of the base layer and a decoded image of the enhancement layer by decoding the base layer so as to generate a decoded image with distortion, and by decoding the enhancement layer without the base layer. The decoded image of the base layer is an image in which encoding distortion is superimposed onto an original image, and the decoded image of the enhancement layer is an image representing an error in which the sign of the encoding distortion superimposed onto the original image is inverted. When a lossless image is displayed, the image decoding device 1002 displays a result of adding a lossy decoded image of the base layer and the decoded image of the enhancement layer.

Scalable encoding according to HEVC (SHVC) is different from scalable encoding according to MPEG-2, AVC, or the like, and a process of decoding a CU in the enhancement layer is the same as a decoding process in the base layer. Information (an encoding mode, a decoded pixel value, and the like) of the base layer is referred to in order to improve the compression efficiency of the enhancement layer, but only the decoded pixel value can be referred to according to SHVC. In particular, the decoded pixel value can be referred to by handling a decoded image of the base layer as one of reference images of the enhancement layer.

A process of decoding an image-level parameter of reference image information or the like is slightly different between the base layer and the enhancement layer, but a circuit that processes the base layer and a circuit that processes the enhancement layer can be shared in a process of decoding a CU.

According to the SHVC standard, inter-prediction encoding and intra-prediction encoding can be switched for each CU also in the enhancement layer. Further, in inter-prediction encoding, a decoded image of another image in the enhancement layer, and a decoded image that corresponds to the same image or a decoded image that corresponds to another image in the base layer can be switched for each CU, and can be used as a reference image.

However, in encoding the enhancement layer according to the embodiments, inter-prediction encoding is performed on all CUs in an image, and only a decoded image that corresponds to the same image in the base layer is used as a reference image. Consequently, encoding distortion included in the decoded image of the base layer can be restored by using only the enhancement layer. The SHVC standard specifies that both the base layer and the enhancement layer are decoded, but specified conditions can be relaxed by employing encoding of the enhancement layer as described above.

More specifically, as an encoding mode of all CUs of the enhancement layer, an inter-prediction encoding mode for using a decoded image that corresponds to the same image in the base layer as a reference image and using a motion vector for which a magnitude is 0 is employed. When the inter-prediction encoding described above is performed, an encoded pixel value of each of the CUs in the enhancement layer is a difference between a pixel value of an original image and a decoded pixel value obtained by decoding a lossy encoded image.

Further, the HEVC standard strictly specifies an operation in a case in which a reference image does not exist in the decoded image buffer due to a transmission error or the like. Specifically, the HEVC standard specifies that an image for which luminance and a color difference component have medians on the entirety of a screen is used as a reference image. As an example, in the case of an 8-bit image, a median is 128. Therefore, even when the enhancement layer is decoded without the base layer, a decoding result can be determined uniquely.

Accordingly, when the enhancement layer according to the embodiments is decoded without the base layer, an addition result of adding a median to a value in which the sign of encoding distortion by lossy encoding is inverted is generated. Therefore, the image decoding device 1002 can completely restore an original image by adding the obtained addition result to the decoded image of the base layer and subtracting the median uniformly on the screen.

As an example, when a pixel value A of a certain pixel of an original image is lossy-encoded in the base layer, and a decoded pixel value A′ is obtained by decoding, encoding distortion by lossy encoding is A′-A. On the other hand, in lossless encoding of the enhancement layer, a decoded image that corresponds to the same image in the base layer is referred to, and a motion vector for which a magnitude is 0 is used, and therefore a decoded pixel value at the time of lossy encoding is used as a pixel value of a predicted image in all of the CUs. Accordingly, lossless encoding is performed on A-A′ in the enhancement layer.

Here, when the enhancement layer is decoded without the base layer, the value A-A′+B that is obtained by adding a median B to A-A′ is obtained. When the value A-A′+B is added to the decoded pixel value A′, A+B is obtained, and an original pixel value A is restored by subtracting the median B from A+B.

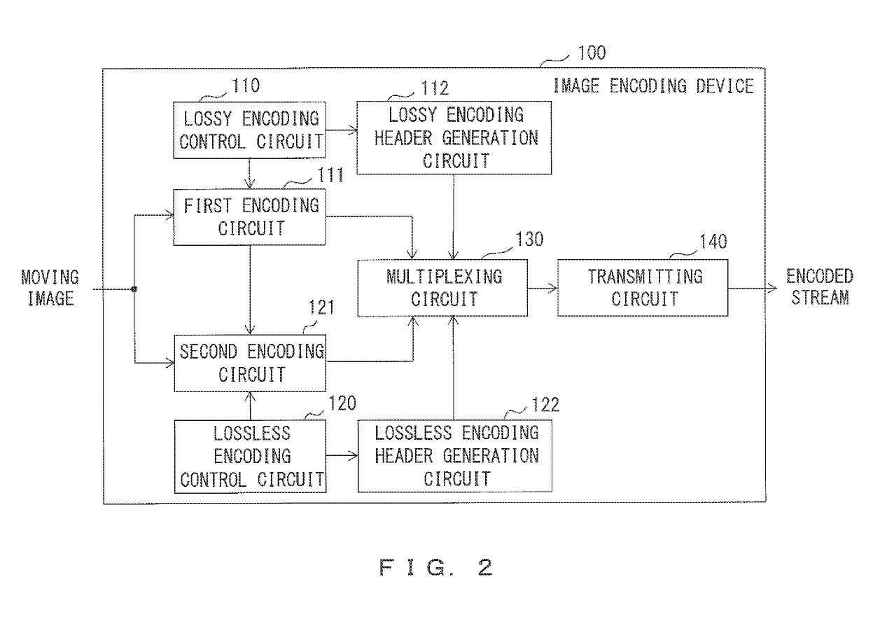

FIG. 2 illustrates an exemplary configuration of an image encoding device according to the embodiments. An image encoding device 100 of FIG. 1 includes a lossy encoding control circuit (a lossy encoding controller) 110, a first encoding circuit (a first encoder) 111, a lossy encoding header generation circuit (a lossy encoding header generator) 112, a lossless encoding control circuit (a lossless encoding controller) 120, a second encoding circuit (a second encoder) 121, a lossless encoding header generation circuit (a lossless encoding header generator) 122, a multiplexing circuit (a multiplexer) 130, and a transmitting circuit (a transmitter) 140. The first encoding circuit 111 and the second encoding circuit 121 respectively correspond to the encoding circuit 1100 and the encoding circuit 1200 of FIG. 1.

The image encoding device 100 performs quality scalable video coding including two layers, a lossy base layer and a lossless enhancement layer, on each frame included in a moving image, and outputs an encoded stream. An image to be encoded that correspond to each of the frames may be a color image, or may be a monochrome image. In the case of a color image, a pixel value may be in an RGB format, or may be in a color difference format. The color difference format may be 4:4:4, 4:2:2, 4:2:0, or 4:0:0.

The image encoding device 100 can be implemented, for example, as a hardware circuit. In this case, the image encoding device 100 may include respective components as individual circuits, or may be one integrated circuit.

The lossy encoding control circuit 110 outputs a control signal that controls the first encoding circuit 111 and the lossy encoding header generation circuit 112. This control signal is a signal that specifies an encoding mode, a quantization parameter, and the like of each image to be encoded. The encoding mode represents, for example, only intra-prediction encoding or a mixture of intra-prediction encoding and inter-prediction encoding. As a reference image that is referred to in inter-prediction encoding, a locally decoded image of the base layer is specified.

The first encoding circuit 111 applies lossy encoding to an image to be encoded, and generates and outputs an encoded image of the base layer for each CU. The generated encoded image conforms to a single-layer encoding specification according to the HEVC standard.

The lossy encoding header generation circuit 112 generates and outputs encoding parameters in units of slices, images, and sequences at the time of lossy encoding that conforms to the single-layer encoding specification according to the HEVC standard.

The lossless encoding control circuit 120 outputs a control signal that controls the second encoding circuit 121 and the lossless encoding header generation circuit 122. This control signal is a signal that specifies an encoding mode of each image to be encoded, lossless encoding, and the like. The encoding mode represents, for example, only intra-prediction encoding in all CUs or only inter-prediction encoding for using a decoded image that corresponds to the same image that is output by the first encoding circuit 111 as a reference image in all of the CUs.

The second encoding circuit 121 applies lossless encoding to each image to be encoded, and generates and outputs an encoded image of the enhancement layer for each of the CUs. The generated encoded image conforms to the single-layer encoding specification according to the HEVC standard.

The lossless encoding header generation circuit 122 generates and outputs encoding parameters in units of slices, images, and sequences at the time of lossless encoding that conforms to a plural-layer encoding specification according to the HEVC standard.

The multiplexing circuit 130 multiplexes outputs of the lossy encoding header generation circuit 112, the first encoding circuit 111, the lossless encoding header generation circuit 122, and the second encoding circuit 121, and generates encoded data of a 2-layer quality scalable video coding moving image.

The transmitting circuit 140 accumulates the encoded data (the encoded images and the encoding parameters) that is output by the multiplexing circuit 130, and stores the encoded data as an encoded stream. The transmitting circuit 140 transmits only an encoded stream of the base layer, only an encoded stream of the enhancement layer, or both the encoded stream of the base layer and the encoded stream of the enhancement layer to an image decoding device in accordance with a request from the image decoding device.

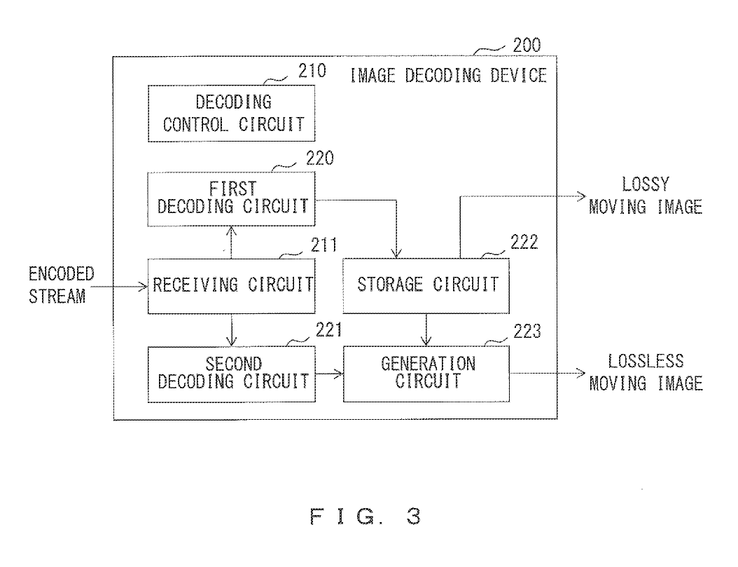

FIG. 3 illustrates an exemplary configuration of an image decoding device according to the embodiments. An image decoding device 200 of FIG. 3 includes a decoding control circuit (a decoding controller) 210, a receiving circuit (a receiver) 211, a first decoding circuit (a first decoder) 220, a second decoding circuit (a second decoder) 221, a storage circuit 222, and a generation circuit (a generator) 223. The first decoding circuit 220 and the second decoding circuit 221 respectively correspond to the decoding circuit 1300 and the decoding circuit 1400 of FIG. 1.

The image decoding device 200 can be implemented, for example, as a hardware circuit. In this case, the image decoding device 200 may include respective components as individual circuits, or may be one integrated circuit.

The decoding control circuit 210 outputs a control signal that controls the respective components of the image decoding device 200 in order to perform lossy decoding or lossless decoding on an encoded stream and display a decoded image on a screen. In FIG. 3, control signals that are output from the decoding control circuit 210 to the receiving circuit 211, the first decoding circuit 220, the second decoding circuit 221, the storage circuit 222, and the generation circuit 223 are omitted.

When the decoding control circuit 210 displays a lossy decoded image, the decoding control circuit 210 requests only an encoded stream of the base layer from the image encoding device 100, and the receiving circuit 211 receives the encoded stream of the base layer, and outputs the encoded stream to the first decoding circuit 220.

When the decoding control circuit 210 displays a lossless decoded image, the decoding control circuit 210 requests only an encoded stream of the enhancement layer or encoded streams of both the base layer and the enhancement layer from the image encoding device 100. Upon receipt of the encoded steam of the base layer, the receiving circuit 211 outputs the received encoded stream to the first decoding circuit 220. Upon receipt of the encoded stream of the enhancement layer, the receiving circuit 211 outputs the received encoded stream to the second decoding circuit 221.

The decoding control circuit 210 can request an encoded stream in a prescribed unit from the image encoding device 100. The decoding control circuit 210 can specify a time width, or can specify a specific image as the prescribed unit.

The first decoding circuit 220 decodes an encoded image included in the encoded stream of the base layer, and generates and outputs a lossy decoded image. The second decoding circuit 221 decodes an encoded image included in the encoded stream of the enhancement layer, and generates and outputs a decoded image representing encoding distortion.

The storage circuit 222 stores the lossy decoded image that is output by the first decoding circuit 220, and the decoding control circuit 210 performs control to display a lossy decoded image stream stored in the storage circuit 222 as a lossy moving image on the screen.

The generation circuit 223 adds a pixel value of the lossy decoded image stored in the storage circuit 222 and a pixel value of the decoded image that is output by the second decoding circuit 221, both the lossy decoded image and the decoded image output by the second decoding circuit 221 corresponding to the same original image. The generation circuit 223 subtracts a prescribed pixel value that corresponds to a median or the like from an obtained addition result, and generates a lossless decoded image. The decoding control circuit 210 performs control to display a lossless decoded image stream as a lossless moving image on the screen.

After the lossy moving image is displayed, a request to display detailed information of one image may be made by an operator, an application program, or the like. In this case, the decoding control circuit 210 may request, from the image encoding device 100, only a specific encoded image that corresponds to the requested image among encoded images included in the encoded stream of the enhancement layer.

As an example, when a doctor observes multi-slice images from a slice image of the head to a slice image of the toes as a continuous moving image, the decoding control circuit 210 requests only an encoded stream of the base layer from the image encoding device 100. Accordingly, only the encoded stream of the base layer is transmitted from the image encoding device 100 to the image decoding device 200. Consequently, a transmission rate is reduced in comparison with a case in which encoded streams of both the base layer and the enhancement layer are transmitted.

Then, when the doctor observes a slice image of interest of the chest or the like in detail, the decoding control circuit 210 requests only an encoded image of the enhancement layer that corresponds to a slice image specified by the doctor from the image encoding device 100. Accordingly, only the encoded image of the enhancement layer is transmitted from the image encoding device 100 to the image decoding device 200. The image decoding device 200 decodes only the encoded image of the enhancement layer and adds the stored lossy decoded image to the decoded image such that the image decoding device 200 can display a lossless decoded image without performing lossy decoding again.

The following effects can be achieved by employing the image encoding device 100 of FIG. 2 and the image decoding device 200 of FIG. 3.

(1) A lossy decoded image and a lossless decoded image can be switched flexibly and simply, and a communication network between an image encoding device and an image decoding device can be used effectively.

An encoded stream of the base layer and an encoded stream of the enhancement layer can be transmitted at different timings from each other, and therefore a transmission rate is reduced in comparison with a case in which both of the encoded streams are transmitted simultaneously.

(2) Both lossless encoding and lossy encoding can be handled due to quality scalable video coding. In particular, an encoding parameter and an encoded image completely conform to SHVC, and therefore the encoding parameter and the encoded image can be decoded normally by using an image decoding device that conforms to SHVC.

(3) By applying quality scalable video coding according to HEVC, the total amount of information (the sum of an amount of information of the base layer and an amount of information of the enhancement layer) can be reduced in comparison with a case in which lossless encoding is simply performed according to HEVC or a case in which lossless encoding is performed by using still image encoding such as JPEG 2000.

As an example, in the case of a multi-slice CT image (512 pixels×512 pixels) for which precision is 12 bits and a color difference format is 4:0:0, an amount of information can be reduced by about 15%. In this case, a quantization parameter of lossy encoding is set to around 0, but the magnitude of quantization distortion at the time of using a quantization parameter of 0 is 16 times the magnitude of quantization distortion at the time of using the minimum value −24 of the quantization parameter. In addition, inter-prediction encoding is applied to lossy encoding.

A most significant bit (MSB) component of a 12-bit signal has a high correlation in an image and between images, and therefore an amount of information can be greatly reduced by applying inter-prediction encoding and frequency conversion. On the other hand, a least-significant bit (LSB) component of the 12-bit signal that remains as encoding distortion has a low correlation in an image and between images, and therefore it can be said that lossless encoding according to HEVC is sufficiently usable.

(4) A circuit configuration of the image decoding device can be simplified. Specifically, a decoding circuit for a CU of the base layer and a decoding circuit for a CU of the enhancement layer can be shared.

The image encoding device 100 of FIG. 2 and the image decoding device 200 of FIG. 3 are used for various purposes. As an example, the image encoding device 100 or the image decoding device 200 can be incorporated into a video camera, a moving image transmitter, a moving image receiver, a video telephone system, a computer, or a portable telephone.

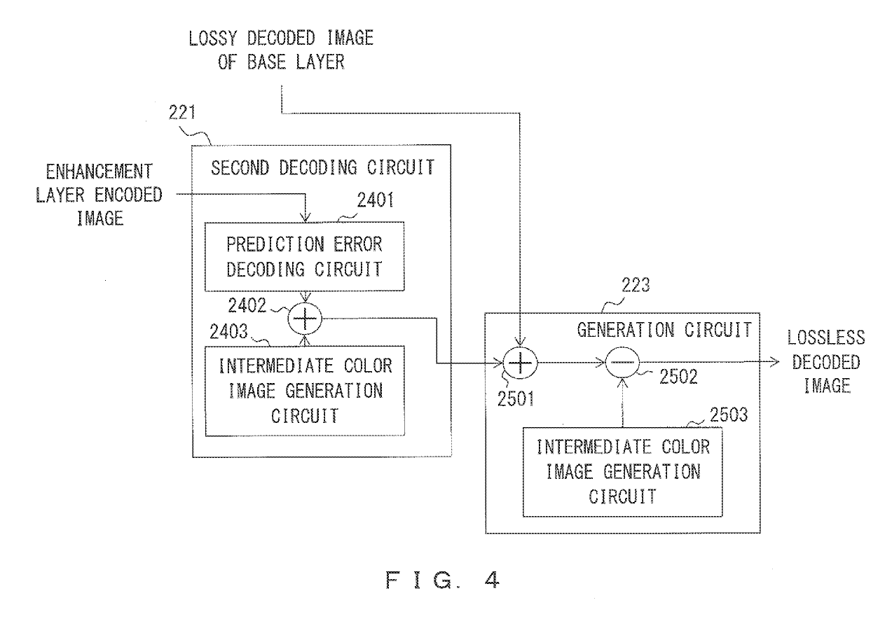

FIG. 4 illustrates exemplary configurations of the second decoding circuit 221 and the generation circuit 223 of FIG. 3. A second decoding circuit 221 of FIG. 4 includes a prediction error decoding circuit (a prediction error decoder) 2401, an addition circuit (an adder) 2402, and an intermediate color image generation circuit (an intermediate color image generator) 2403.

The prediction error decoding circuit 2401 corresponds to the prediction error decoding circuit 1401 of FIG. 1, and the prediction error decoding circuit 2401 decodes an encoded image of the enhancement layer for each CU, and generates a decoding result that corresponds to a value obtained by inverting the sign of encoding distortion of the base layer.

The intermediate color image generation circuit 2403 generates a virtual intermediate color image in which pixel values of all pixels are a median. According to the HEVC standard, when a reference image does not exist in the decoded image buffer, this intermediate color image is inserted into the decoded image buffer, and is used as the reference image. As an example, when an image to be encoded has a precision of N bits, (Y,Cb,Cr)=(2̂(N−1),2̂(N−1),2̂ (N−1)) can be used as a median.

The addition circuit 2402 corresponds to the addition circuit 1402 of FIG. 3, and the addition circuit 2402 adds the decoding result generated by the prediction error decoding circuit 2401 and a pixel value of the intermediate color image generated by the intermediate color image generation circuit 2403 in CU units, and outputs an addition result as a pixel value of a decoded image. Consequently, even when the decoding result generated by the prediction error decoding circuit 2401 has a negative value, a decoded image having a positive pixel value can be output from the second decoding circuit 221.

The generation circuit 223 includes an addition circuit (an adder) 2501, a subtraction circuit (a subtracter) 2502, and an intermediate color image generation circuit (an intermediate color image generator) 2503. The addition circuit 2501 adds a pixel value of the lossy decoded image stored in the storage circuit 222 and a pixel value of the decoded image output by the second decoding circuit 221 in image units, and outputs an addition result. The intermediate color image generation circuit 2503 generates an intermediate color image similarly to the intermediate color image generation circuit 2403. The subtraction circuit 2502 subtracts a pixel value of the intermediate color image generated by the intermediate color image generation circuit 2503 from the addition result that is output by the addition circuit 2501 in image units, and generates a lossless decoded image of the enhancement layer.

A decoded image that corresponds to the same image in the base layer is referred to for all CUs of the enhancement layer, and under a condition that a motion vector becomes 0, the lossless decoded image that is output by the generation circuit 223 completely matches the lossless decoded image that is output by the decoding circuit 1400 of FIG. 1.

In the configuration of FIG. 4, the decoded image buffer 1403 and the predicted image generation circuit 1404 of FIG. 1 can be omitted, and the configuration of the second decoding circuit 221 that generates a lossless decoded image is simplified. Consequently, a load of a process for receiving an encoded stream on the image decoding device 200 is reduced.

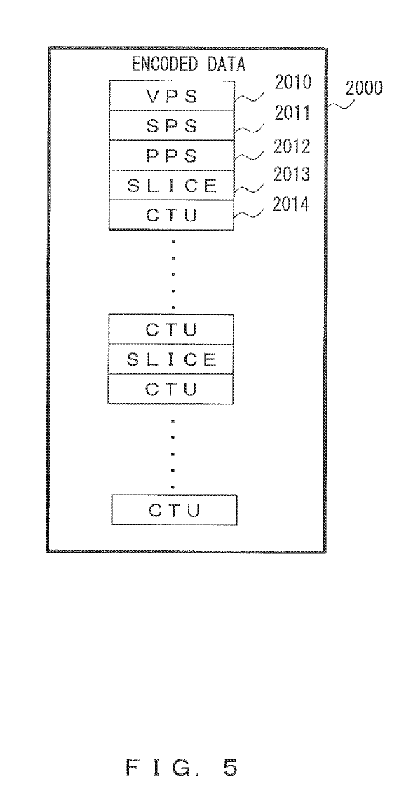

FIG. 5 illustrates an example of encoded data that corresponds to one image to be encoded in the base layer or the enhancement layer. Encoded data 2000 of FIG. 5 includes a video parameter set (VPS) 2010, a sequence parameter set (SPS) 2011, a picture parameter set (PPS) 2012, and a slice segment header (SLICE) 2013. The encoded data 2000 further includes a coded tree unit (CTU) 2014.

The VPS 2010 describes a parameter of a layer. In the case of the base layer, the VPS 2010 is added to at least an encoded image that starts redrawing. In the case of the enhancement layer, the VPS 2010 is added to all of the encoded images.

Parameters included in the VPS 2010 are common to the base layer and the enhancement layer. Among these parameters, the following parameters are used, for example, as a parameter relating to quality scalable video coding.

VpsBaseLayerInternalFlag: This is a parameter of the base layer, and the value ‘1’ representing that encoded data is included in an encoded moving image is set.

VpsBaseLayerAvailableFlag: The value ‘1’ representing that an encoded image of the base layer is included in an encoded moving image is set.

VpsMaxLayersMinus1: The value ‘1’ representing two layers is set.

ProfileTierLevel: This describes a scalable encoding profile (such as a MainScalable profile) of the enhancement layer and a single-layer encoding profile (such as a Main profile) of the base layer.

ScalabilityMaskFlag[i]: Only when i is 0, the value ‘1’ that corresponds to two layers is set.

DimensionIdLenMinus[0]: The value ‘0’ that corresponds to two layers is set.

VpsNuhLayerIdPresentFlag: The value ‘1’ is set in order to describe NuhLayerId of the enhancement layer.

LayerIdInNuh: The value ‘1’ is set as NuhLayerId of the enhancement layer.

DimensionId[1][0]: The value ‘2’ that represents quality scalable video coding is set.

DirectDependencyFlag[1][0]: The value ‘1’ that represents that the enhancement layer refers to the base layer is set.

VpsNumProfileTierLevelMinus1: The value ‘1’ that corresponds to two layers is set.

MaxOneActiveRefLayerFlag: The value ‘1’ is set because only two layers exist.

The SPS 2011 describes a parameter that is common to a sequence in each layer. In the case of the base layer, the SPS 2011 is added to at least an encoded image that starts redrawing. In the case of the enhancement layer, the SPS 2011 is added to all of the encoded images.

A parameter included in the SPS 2011 is different between the base layer and the enhancement layer. The following parameters are used, for example, as a parameter relating to quality scalable video coding.

NumShortTermRefPicSets: In the case of the enhancement layer only, the value ‘0’ representing that reference is not performed between the enhancement layers is set.

LongTermRefPicsPresentFlag: The value ‘0’ is set. According to a VPS parameter, a decoded image of the base layer is used as a reference image of the enhancement layer by default.

The PPS 2012 describes a parameter that is common to a plurality of images in each layer. In the case of the base layer, the PPS 2012 is added to at least an encoded image that stars redrawing. In the case of the enhancement layer, the PPS 2012 is added to all of the encoded images.

A parameter included in the PPS 2012 is different between the base layer and the enhancement layer. The following parameters are used, for example, as a parameter relating to quality scalable video coding.

InitQpMinus26: In the case of the enhancement layer, a value representing that a quantization parameter QP has a minimum value is set. This value depends on bit precision of an image, and in the case of an 8-bit image, ‘-26’ is set.

CuQpDeltaEnabledFlag: In the case of the enhancement layer, quantization is not performed, and therefore the value ‘0’ is set.

TransquantBypassEnableFlag: In the case of the enhancement layer, the value ‘1’ representing that lossless encoding is performed is set.

The slice segment header 2013 describes a parameter that is common to a slice. One or more slice segment headers 2013 are added to each encoded image.

A parameter included in the slice segment header 2013 is different between the base layer and the enhancement layer. The following parameters are used, for example, as a parameter relating to quality scalable video coding.

SliceType: In the case of the enhancement layer only, the value ‘1’ representing a P-picture is always set.

ShortTermRefPicSetSpsFlag: In the case of the enhancement layer only, the value ‘1’ representing that the SPS 2011 is referred to is set.

InterLayerPredEnabledFlag: In the case of the enhancement layer only, the value ‘1’ representing that reference is performed between layers is set.

SliceQpDelta: In the case of the enhancement layer only, the value ‘0’ representing that lossless encoding is performed is set.

A prescribed number of the CTUs 2014 appear that corresponds to the number of CTUs in an image to be encoded. Each of the CTUs is a block of 64 pixels×64 pixels, and includes one or more CUs. Each of the CUs includes an encoded image of a corresponding CU and a parameter.

The parameter included in each of the CUs is different between the base layer and the enhancement layer. The following parameters are used, for example, as a parameter relating to quality scalable video coding. The setting below is applied to all of the CUs of the enhancement layer.

CuTransquantBypassFlag: In the case of the enhancement layer only, the value ‘1’ representing that lossless encoding is performed is set.

PredModeFlag: In the case of the enhancement layer only, the value ‘0’ that represents an inter-prediction mode is set.

PredictionUnit: In the case of the enhancement layer only, a reference image (a reference picture) for which RefIdx is 0 is referred to, and setting is performed in such away that a decoded motion vector becomes (0, 0). As the reference image for which RefIdx is 0, a decoded image that corresponds to the same image in the base layer is allocated.

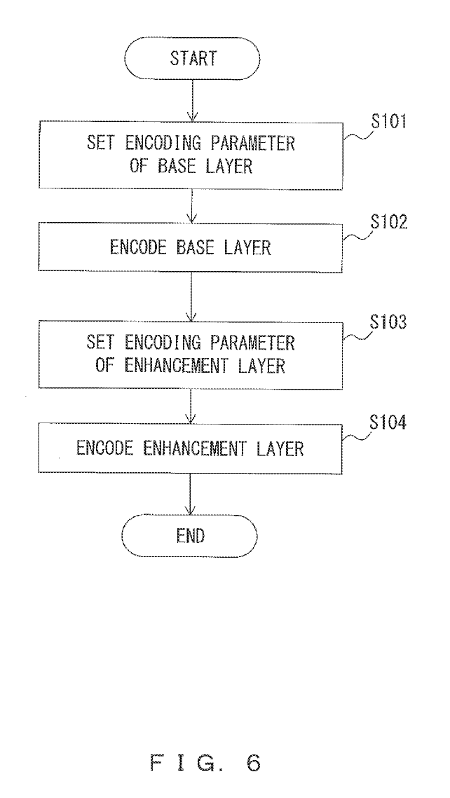

FIG. 6 is a flowchart illustrating an example of image encoding processing performed by the image encoding device 100 of FIG. 2. This image encoding processing is processing for performing lossy encoding and lossless encoding on an image to be encoded at time t that is included in a moving image to be encoded.

First, the lossy encoding header generation circuit 112 sets an encoding parameter of the base layer (step S101). At this time, the lossy encoding header generation circuit 112 determines an encoding mode and an encoding parameter of each CU in an image to be encoded in accordance with image quality (a bit rate, a quantization parameter, and the like) specified by an operator, an application program, or the like.

The encoding mode is a single-layer encoding scheme, and the encoding mode is either intra-prediction encoding or inter-prediction encoding for referring to only a decoded image of the base layer. The encoding parameter is a parameter of lossy encoding, and the quantization parameter is set to a value that is at least greater than or equal to a minimum value (in the case of an 8-bit image, 0). In addition, TransquantBypassEnableFlag or CuTransquantBypassFlag is set to 0.

Then, the first encoding circuit 111 performs lossy encoding on the image to be encoded, and generates an encoded image of the base layer and a locally decoded image LR(t) at time t (step S102).

The lossless encoding header generation circuit 122 sets an encoding parameter of the enhancement layer (step S103). At this time, the lossless encoding header generation circuit 122 sets only a locally decoded image LR(t) of the base layer as a reference image list of the entirety of the image to be encoded. This setting can be realized by setting NumShortTermRefPicSets to 0 and setting LongTermRefPicsPresentFlag to 0.

The encoding mode of each of the CUs in the image to be encoded is always inter-prediction encoding, RefIdx of a reference image is set to 0 (this corresponds to the locally decoded image LR(t) of the base layer), and the motion vector (MVx,MVy) is set to (0,0). In addition, TransquantBypassEnableFlag and CuTransquantBypassFlag are set to 1.

Then, the second encoding circuit 121 performs lossless encoding on the image to be encoded, and generates an encoded image of the enhancement layer (step S104).

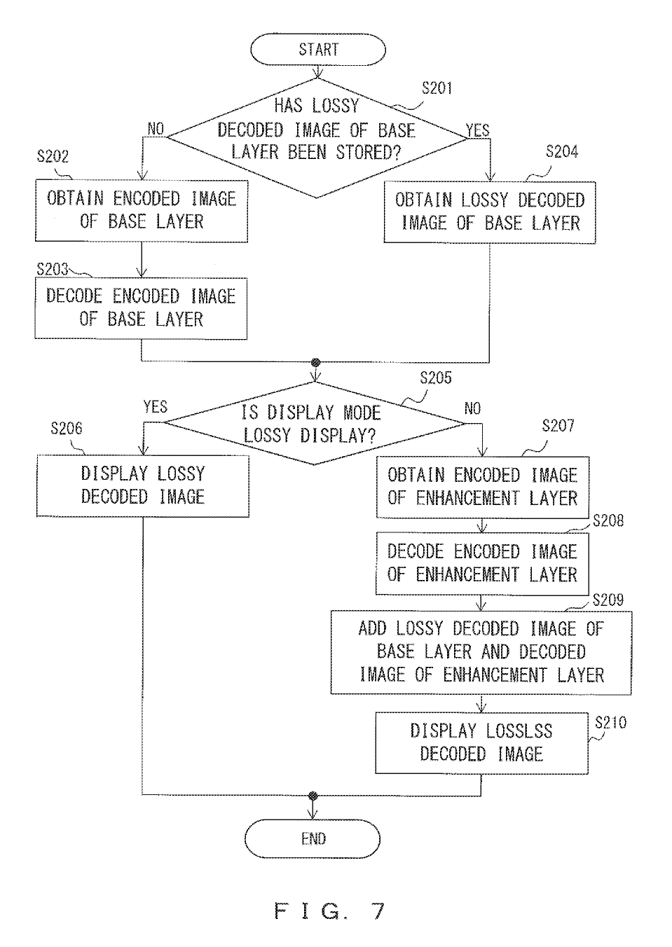

FIG. 7 is a flowchart illustrating an example of image decoding processing performed by the image decoding device 200 of FIG. 3. This image decoding process is processing for decoding an encoded image at time t and displaying a decoded image on a screen.

First, the decoding control circuit 210 checks whether a lossy decoded image P(t) of the base layer at time t has been stored in the storage circuit 222 (step S201). As an example, when an encoded stream of the base layer has been previously received, and a lossy decoded image of the base layer has been already displayed, the lossy decoded image P(t) has been stored in the storage circuit 222. When the encoded stream of the base layer has not yet been received, the lossy decoded image P(t) has not been stored in the storage circuit 222.

When the lossy decoded image P(t) has not been stored (step S201, NO), the decoding control circuit 210 requests an encoded stream of the base layer for generating the lossy decoded image P(t) from the image encoding device 100 (step S202). Then, the receiving circuit 211 receives the encoded stream that is transmitted from the image encoding device 100. The first decoding circuit 220 decodes an encoded image included in the received encoded stream, generates a lossy decoded image P(t), and stores the lossy decoded image P(t) in the storage circuit 222 (step S203).

When the lossy decoded image P(t) has been stored (step S201, YES), the decoding control circuit 210 obtains the lossy decoded image P(t) from the storage circuit 222 (step S204).

Then, the decoding control circuit 210 checks whether a display mode specified by the operator, the application program, or the like is lossy display or lossless display (step S205).

When the display mode is lossy display (step S205, YES), the decoding control circuit 210 performs control to display the lossy decoded image P(t) on a screen (step S206).

When the display mode is lossless display, the decoding control circuit 210 requests encoded data of the enhancement layer at time t from the image encoding device 100 (Step S207). The receiving circuit 211 receives the encoded data transmitted from the image encoding device 100.

Then, the second decoding circuit 221 decodes an encoded image that is included in the received encoded data, and generates a decoded image Q(t) of the enhancement layer that represents encoding distortion at time t (step S208). The generation circuit 223 adds the lossy decoded image P(T) and the decoded image Q(t), and subtracts a prescribed pixel value from the addition result so as to generate a lossless decoded image R(t) of the enhancement layer at time t (step S209). The decoding control circuit 210 performs control to display the lossless decoded image R(t) on the screen (step S210).

The configurations of the image processing system of FIG. 3, the image encoding device 100 of FIG. 2, and the image decoding devices 200 of FIG. 3 an FIG. 4 are examples, and some components may be omitted or changed according to the applications or conditions of the image encoding device and the image decoding device.

As an example, in a case in which the configuration of the image decoding device 200 of FIG. 3 is employed as the image decoding device 1002 of FIG. 1, the decoded image buffer 1403 and the predicted image generation circuit 1404 of FIG. 1 can be omitted.

An image generation circuit that generates an image in which pixel values of all pixels are a fixed value other than a median may be used instead of the intermediate color image generation circuit 2403 and the intermediate color image generation circuit 2503 of FIG. 4. In addition, the addition circuit 2501 can directly add a pixel value of the lossy decoded image stored in the storage circuit 222 and a decoding result generated by the prediction error decoding circuit 2401 so as to generate a lossless decoded image of the enhancement layer. In this case, the addition circuit 2402, the intermediate color image generation circuit 2403, the subtraction circuit 2502, and the intermediate color image generation circuit 2503 can be omitted.

Quality scalable video coding of three or more layers may be performed instead of performing quality scalable video coding of two layers. In addition, another encoding scheme for generating an encoded stream encoded by irreversible encoding and an encoded stream encoded by reversible encoding may be used instead of quality scalable video coding according to HEVC.

The flowcharts of FIG. 6 and FIG. 7 are examples, and some processes may be omitted or changed according to the configurations or conditions of the image encoding device and the image decoding device. As an example, in the image encoding processing of FIG. 6, in a case in which encoding parameters of the base layer and the enhancement layer have been set, the processes of steps S101 and S104 can be omitted.

In step S209 of FIG. 7, the addition circuit 2501 may directly add a pixel value of the lossy decoded image stored in the storage circuit 222 and a decoding result generated by the prediction error decoding circuit 2401 so as to generate a lossless decoded image of the enhancement layer.

The image to be encoded is not limited to a medical image, and may be another image to which both irreversible encoding and reversible encoding are applied.

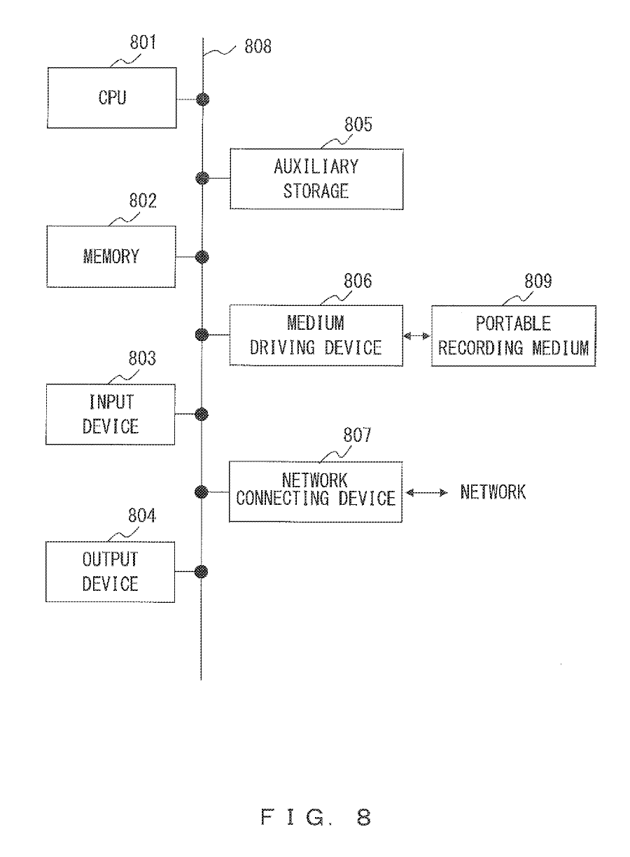

The image encoding device 1001 and the image decoding device 1002 of FIG. 1, the image encoding device 100 of FIG. 2, and the image decoding device 200 of FIG. 3 can be implemented as hardware circuits, and can be implemented by using an information processing device (a computer) illustrated in FIG. 8.

The information processing device of FIG. 8 includes a central processing unit (CPU) 801, a memory 802, an input device 803, an output device 804, an auxiliary storage 805, a medium driving device 806, and a network connecting device 807. These components are connected to each other via a bus 808.

The memory 802 is a semiconductor memory such as a read only memory (ROM), a random access memory (RAM), or a flash memory, and the memory 802 stores a program and data used in the image encoding processing or the image decoding processing. The memory 802 can be used as the decoded image buffer 1105, the decoded image buffer 1205, the decoded image buffer 1303, or the decoded image buffer 1403 of FIG. 1. The memory 802 can also be used as the storage circuit 222 of FIG. 3.

The CPU 801 (a processor) operates as the encoding circuit 1100, the subtraction circuit 1101, the prediction error encoding circuit 1102, the prediction error decoding circuit 1103, the addition circuit 1104, and the predicted image generation circuit 1106 of FIG. 1 by executing a program by using, for example, the memory 802. The CPU 801 also operates as the encoding circuit 1200, the subtraction circuit 1201, the prediction error encoding circuit 1202, the prediction error decoding circuit 1203, the addition circuit 1204, and the predicted image generation circuit 1206 of FIG. 1.

The CPU 801 also operates as the decoding circuit 1300, the prediction error decoding circuit 1301, the addition circuit 1302, the predicted image generation circuit 1304, the decoding circuit 1400, the prediction error decoding circuit 1401, the addition circuit 1402, and the predicted image generation circuit 1404 of FIG. 1.

The CPU 801 also operates as the lossy encoding control circuit 110, the first encoding circuit 111, the lossy encoding header generation circuit 112, the lossless encoding control circuit 120, the second encoding circuit 121, the lossless encoding header generation circuit 122, and the multiplexing circuit 130 of FIG. 2. The CPU 801 also operates as the decoding control circuit 210, the first decoding circuit 220, the second decoding circuit 221, and the generation circuit 223 of FIG. 3, and the prediction error decoding circuit 2401, the addition circuit 2402, the intermediate color image generation circuit 2403, the addition circuit 2501, the subtraction circuit 2502, and the intermediate color image generation circuit 2503 of FIG. 4.

The input device 803 is, for example, a keyboard, a pointing device, or the like, and the input device 803 is used to input an instruction or information from a user or an operator. The output device 804 is, for example, a display device, a printer, a speaker, or the like, and the output device 804 is used to output an inquiry or a processing result to a user or an operator. The processing result includes a lossy decoded image or a lossless decoded image.

The auxiliary storage 805 is, for example, a magnetic disk device, an optical disk device, a magneto-optical disk device, a tape device, or the like. The auxiliary storage 805 may be a hard disk drive. The auxiliary storage 805 can be used as the storage circuit 222 of FIG. 3. The information processing device can store a program and data in the auxiliary storage 805, and can load them into the memory 802 and use them.

The medium driving device 806 drives a portable recording medium 809, and accesses its recording content. The portable recording medium 809 is a memory device, a flexible disk, an optical disk, a magneto-optical disk, or the like. The portable recording medium 809 may be a compact disk read-only memory (CD-ROM), a digital versatile disk (DVD), or a universal serial bus (USB) memory. A user or an operator can store a program and data in the portable recording medium 809, and can load them into the memory 802 and use them.

As described above, a computer-readable recording medium that stores a program and data used in processing includes a physical (non-transitory) recording medium such as the memory 802, the auxiliary storage 805, or the portable recording medium 809.

The network connecting device 807 is a communication interface that is connected to a communication network such as a local area network (LAN) or the Internet, and that performs data conversion associated with communication. The network connecting device 807 can be used as the transmitting circuit 140 of FIG. 2 or the receiving circuit 211 of FIG. 3. The information processing device can receive a program and data from an external device via the network connecting device 807, and can load them into the memory 802 and use them.

The information processing device does not need to include all of the components in FIG. 8, and some components can be omitted according to applications or conditions. As an example, in a case in which an interface with a user or an operator is not needed, the input device 803 and the output device 804 may be omitted. In addition, in a case in which the information processing device does not access the portable recording medium 809, the medium driving device 806 may be omitted.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An image decoding device comprising:
a memory; and
a processor coupled to the memory and that performs:
requesting a first encoded stream including a first encoded image from an image encoding device that generates the first encoded stream by encoding a plurality of images to be encoded by irreversible encoding, the first encoded image being obtained by encoding one image to be encoded from among the plurality of images to be encoded;
receiving the first encoded stream from the image encoding device;
generating a first decoded image from the first encoded image by decoding the first encoded stream;
storing the first decoded image in the memory;
outputting the first decoded image;
requesting a second encoded stream including a second encoded image from the image encoding device, the second encoded image being obtained by applying inter-prediction to the one image to be encoded and by encoding a prediction error by reversible encoding, the inter-prediction using a locally decoded image obtained by decoding the first encoded image as a reference image and using a motion vector for which a magnitude is 0;
receiving the second encoded stream from the image encoding device;
generating a second decoded image from the second encoded image by decoding the second encoded stream;
generating a third decoded image that corresponds to the first decoded image by using an addition result of adding the first decoded image and the second decoded image; and
outputting the third decoded image.

2. The image decoding device according to claim 1, wherein
the processor generates the second decoded image having a positive pixel value by adding a decoding result of decoding the second encoded image and a prescribed pixel value, and generates the third decoded image by subtracting the prescribed pixel value from the addition result.

3. The image decoding device according to claim 1, wherein
the first encoded image is an encoded image that corresponds to an image for which an output of detailed information is requested from among a plurality of encoded images included in the first encoded stream, and when the processor outputs the third decoded image after outputting the first decoded image, the processor requests, from the image encoding device, the second encoded image that corresponds to the first encoded image from among a plurality of encoded images included in the second encoded stream.

4. An image processing system comprising an image encoding device and an image decoding device, wherein
the image encoding device performs:
generating a first plurality of encoded images including a first encoded image by encoding a plurality of images to be encoded by irreversible encoding, the first encoded image being obtained by encoding one image to be encoded from among the plurality of images to be encoded;
generating a second plurality of encoded images including a second encoded image, the second encoded image being obtained by applying inter-prediction to the one image to be encoded and by encoding a prediction error by reversible encoding, the inter-prediction using a locally decoded image obtained by decoding the first encoded image as a reference image and using a motion vector for which a magnitude is 0; and
transmitting a first encoded stream including the first plurality of encoded images and a second encoded stream including the second plurality of encoded images to the image decoding device, and
the image decoding device performs:
requesting the first encoded stream from the image encoding device;
receiving the first encoded stream from the image encoding device;
generating a first decoded image from the first encoded image by decoding the first encoded stream;
storing the first decoded image in a memory;
outputting the first decoded image;
requesting the second encoded stream from the image encoding device;
receiving the second encoded stream from the image encoding device;
generating a second decoded image from the second encoded image by decoding the second encoded stream;
generating a third decoded image that corresponds to the first decoded image by using an addition result of adding the first decoded image and the second decoded image; and
outputting the third decoded image.

5. The image processing system according to claim 4, wherein
the image decoding device generates the second decoded image having a positive pixel value by adding a decoding result of decoding the second encoded image and a prescribed pixel value, and generates the third decoded image by subtracting the prescribed pixel value from the addition result.

6. The image processing system according to claim 4, wherein
the first encoded image is an encoded image that corresponds to an image for which an output of detailed information is requested from among the first plurality of encoded images, and when the image decoding device outputs the third decoded image after outputting the first decoded image, the image decoding device requests, from the image encoding device, the second encoded image that corresponds to the first encoded image from among the second plurality of encoded images.

7. An image decoding method comprising:
requesting a first encoded stream including a first encoded image from an image encoding device that generates the first encoded stream by encoding a plurality of images to be encoded by irreversible encoding, the first encoded image being obtained by encoding one image to be encoded from among the plurality of images to be encoded;
receiving the first encoded stream from the image encoding device;
generating, by a processor, a first decoded image from the first encoded image by decoding the first encoded stream;
storing the first decoded image in a memory;
outputting the first decoded image;
requesting a second encoded stream including a second encoded image from the image encoding device, the second encoded image being obtained by applying inter-prediction to the one image to be encoded and by encoding a prediction error by reversible encoding, the inter-prediction using a locally decoded image obtained by decoding the first encoded image as a reference image and using a motion vector for which a magnitude is 0;
receiving the second encoded stream from the image encoding device;
generating, by the processor, a second decoded image from the second encoded image by decoding the second encoded stream;
generating, by the processor, a third decoded image that corresponds to the first decoded image by using an addition result of adding the first decoded image and the second decoded image; and
outputting the third decoded image.

8. The image decoding method according to claim 7, wherein
the generating the second decoded image generates the second decoded image having a positive pixel value by adding a decoding result of decoding the second encoded image and a prescribed pixel value, and the generating the third decoded image generates the third decoded image by subtracting the prescribed pixel value from the addition result.

9. The image decoding method according to claim 7, wherein
the first encoded image is an encoded image that corresponds to an image for which an output of detailed information is requested from among a plurality of encoded images included in the first encoded stream, and the requesting the second encoded stream from the image encoding device requests the second encoded image that corresponds to the first encoded image from among a plurality of encoded images included in the second encoded stream.

10. An image decoding device comprising:
a receiving circuit that receives a first encoded stream including a first encoded image from an image encoding device that generates the first encoded stream by encoding a plurality of images to be encoded by irreversible encoding, the first encoded image being obtained by encoding one image to be encoded from among the plurality of images to be encoded, and that receives a second encoded stream including a second encoded image from the image encoding device, the second encoded image being obtained by applying inter-prediction to the one image to be encoded and by encoding a prediction error by reversible encoding, the inter-prediction using a locally decoded image obtained by decoding the first encoded image as a reference image and using a motion vector for which a magnitude is 0;
a first decoding circuit that generates a first decoded image from the first encoded image by decoding the first encoded stream;
a storage circuit that stores the first decoded image;
a second decoding circuit that generates a second decoded image from the second encoded image by decoding the second encoded stream;
a generation circuit that generates a third decoded image that corresponds to the first decoded image by using an addition result of adding the first decoded image and the second decoded image; and
a decoding control circuit that requests the first encoded stream from the image encoding device, makes the first decoding circuit generate the first decoded image, makes the storage circuit store the first decoded image, and outputs the first decoded image, when outputting the first decoded image, and that requests the second encoded stream from the image encoding device, makes the second decoding circuit generate the second decoded image, makes the generation circuit generate the third decoded image, and outputs the third decoded image, when outputting the third decoded image after outputting the first decoded image.
